(19) United States
(12) Patent Application Publication
(10) Pub. No.: US 2008/0195481 A1
(43) Pub. Date: Aug. 14, 2008

(54) PRODUCTS AND PROCESSES FOR GAME PLAY BASED ON ACQUIRED POINTS

(76) Inventor: Howard W. LUTNICK, New York, NY (US)

Correspondence Address: DEAN P. ALDERUCCI, CANTOR FITZGERALD, L.P., 110 EAST 59TH STREET (6TH FLOOR), NEW YORK, NY, 10022, US

(21) Appl. No.: 11/857,126

(22) Filed: Sep. 18, 2007

Related U.S. Application Data
(60) Provisional application No. 60/845,344, filed on Sep. 18, 2006.

(51) Int. Cl. G06Q 30/00; A63F 9/24

(52) U.S. Cl. 705/14; 463/25

(57) ABSTRACT

Methods of entering wagers using incentive awards. Points associated with incentive award programs may be used to play games. Outcomes of the games may determine further point awards. Points may be used to redeem prizes. Incentive award points may be separately maintained from redeemable points. Products and other embodiments are also disclosed.

The present application claims priority to U.S. Provisional Application No. 60/845,344 entitled PRODUCTS AND PROCESSES FOR GAME PLAY BASED ON ACQUIRED POINTS, filed on Sep. 18, 2006, which is hereby incorporated herein by reference.

### BRIEF DESCRIPTION OF THE DRAWINGS

The accompanying drawings are not intended to be drawn to scale. In the drawings, each identical or similar component that is illustrated in various figures is represented by a like numeral. For purposes of clarity, not every component may be labeled or act identified in every drawing. In the drawings:

FIG. 1 shows a computer system arrangement; and

FIG. 2 shows an example process.

### DETAILED DESCRIPTION

The following sections I-X provide a guide to interpreting this patent application.

### I. Terms

The term “product” means any machine, manufacture and/or composition of matter, unless expressly specified otherwise. The term “process” means any process, algorithm, method or the like, unless expressly specified otherwise. Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise. A reference to “another embodiment” in describing an embodiment does not imply that the referenced embodiment is mutually exclusive with another embodiment (e.g., an embodiment described before the referenced embodiment), unless expressly specified otherwise. The terms “including”, “comprising” and variations thereof mean “including but not limited to”, unless expressly specified otherwise. The terms “a”, “an” and “the” mean “one or more”, unless expressly specified otherwise. The term “plurality” means “two or more”, unless expressly specified otherwise.

The term “herein” means “in this patent application, including anything which may be incorporated by reference”, unless expressly specified otherwise. The phrase “at least one of”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”.

The term “represent”, “indicate”, and like terms are not exclusive, unless expressly specified otherwise. For example, the term “represents” do not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms means “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “i.e.” and like terms means “that is”, and thus limits the term or phrase it explains. For example, in the sentence “the computer sends data (i.e., instructions) over the Internet”, the term “i.e.” explains that “instructions” are the “data” that the computer sends over the Internet.

### II. Determining

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The term “determining” does not imply certainty or absolute precision, and therefore “determining” can include estimating, predicting, guessing and the like. The term “determining” does not imply that mathematical processing must be performed, and does not imply that numerical methods must be used, and does not imply that an algorithm or process is used. The term “determining” does not imply that any particular device must be used. For example, a computer need not necessarily perform the determining.

### III. Forms of Sentences

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (I) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device or article is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

### IV. Disclosed Examples and Terminology Are Not Limiting

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments of the invention nor a listing of features of the invention which must be present in all embodiments.

Neither the Title (set forth at the beginning of the first page of this patent application) nor the Abstract (set forth at the end of this patent application) is to be taken as limiting in any way as the scope of the disclosed invention(s). An Abstract has been included in this application merely because an Abstract of not more than 150 words is required under 37 C.F.R. 5 1.72(b). Headings of sections provided in this patent application are for convenience only, and are not to be taken as limiting the disclosure in any way.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not imply that all or any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Any given numerical range shall include whole and fractions of numbers within the range. For example, the range “1 to 10” shall be interpreted to specifically include whole numbers between 1 and 10 (e.g., 1, 2, 3, 4, . . . 9) and non-whole numbers (e.g., 1.1, 1.2, . . . 1.9).

Where two or more terms or phrases are synonymous (e.g., because of an explicit statement that the terms or phrases are synonymous), instances of one such term/phrase does not mean instances of another such term/phrase must have a different meaning. For example, where a statement renders the meaning of “including” to be synonymous with “including but not limited to”, the mere usage of the phrase “including but not limited to” does not mean that the term “including” means something other than “including but not limited to”.

### V. Computing

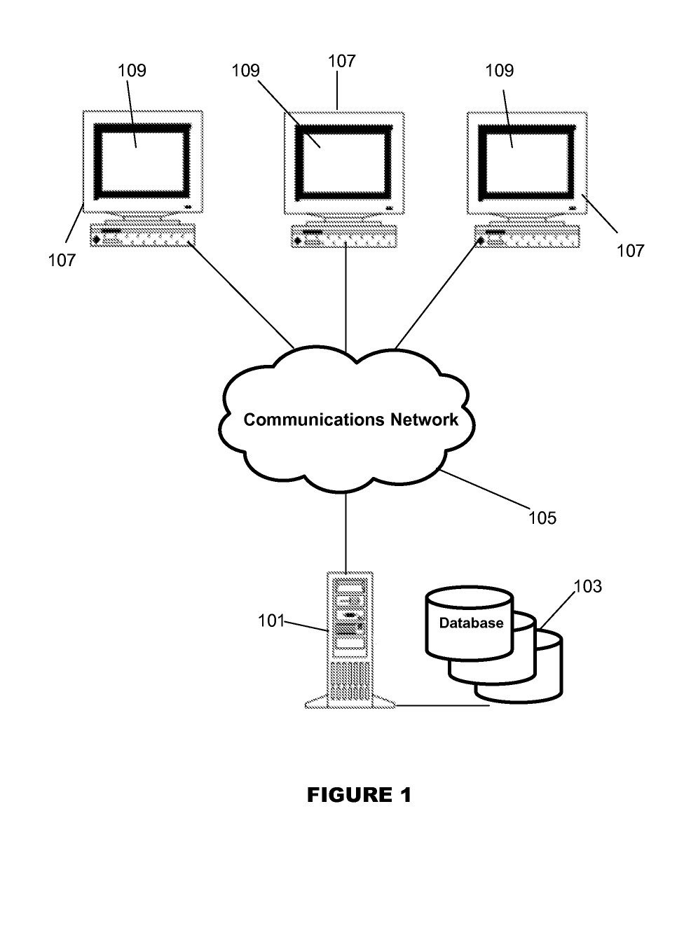

It will be readily apparent to one of ordinary skill in the art that the various processes described herein may be implemented by, e.g., appropriately programmed general purpose computers and computing devices such as is shown in FIG. 1. Typically a processor (e.g., one or more microprocessors, one or more microcontrollers, one or more digital signal processors) will receive instructions (e.g., from a memory or like device), and execute those instructions, thereby performing one or more processes defined by those instructions.

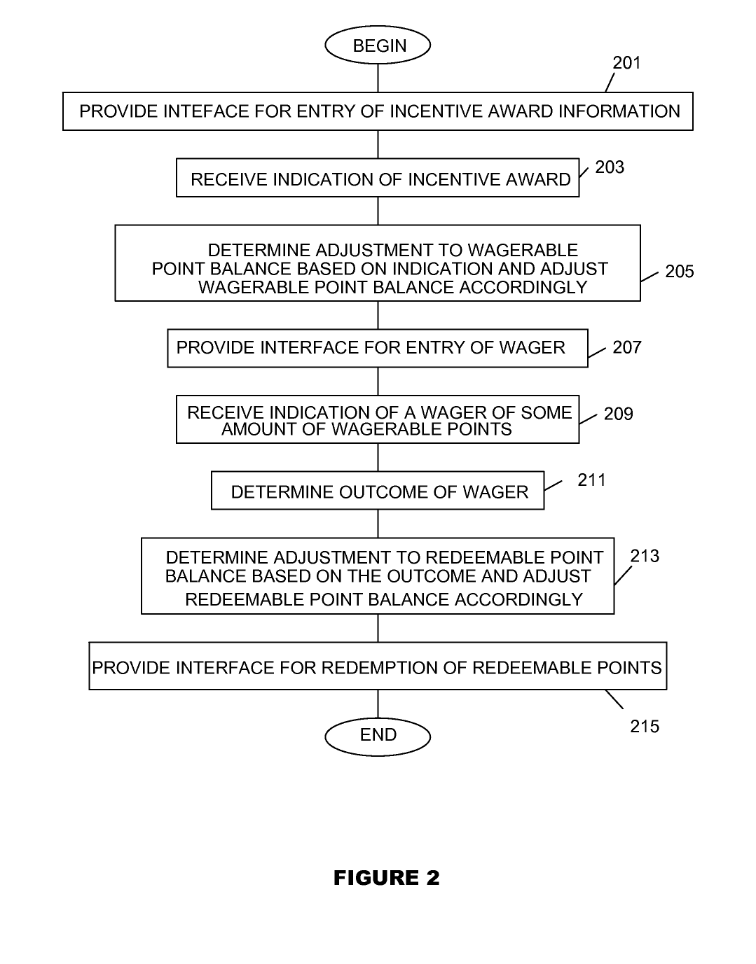

FIG. 1 shows an example computer system arrangement that may be found in some embodiments. As shown, a server computer 101 may execute one of more processes implementing one or more features disclosed herein. The server computer may access a database 103 containing information about wagers, games, players, points, etc. The server computer 101 may be coupled through a communication network 105 (e.g., the Internet and/or one or more LANs) to a remote computer system, such as a personal computer 107 of a customer. The personal computer 107 may execute one of more processes implementing one or more features disclosed herein. For example, the personal computer 107 may execute a web browser that may access a web page maintained by the server computer 101. Such a web page may be displayed through monitor of other display device to prove the user with an interface 109. Together, the personal computer 107 and server computer 101 may enable one or more of the features described herein. A computer arrangement such as that illustrated in FIG. 1 may perform a process such as that illustrated in FIG. 2. It should be recognized that FIG. 1 is given as an example only, and that other embodiments may include any arrangement of devices, including mobile devices, multiple servers or personal computers, and no central servers at all.

A “processor” means one or more microprocessors, central processing units (CPUs), computing devices, microcontrollers, digital signal processors, or like devices or any combination thereof.

Thus a description of a process is likewise a description of an apparatus for performing the process. The apparatus can include, e.g., a processor and those input devices and output devices that are appropriate to perform the process.

Further, programs that implement such processes (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium that participates in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth™, and TCPI/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device which accesses data in such a database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel© Pentium-type or Core-type processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Where a process is described, in an embodiment the process may operate without any user intervention. In another embodiment, the process includes some human intervention (e.g., a step is performed by or with the assistance of a human).

VI. Continuing. Applications

The present disclosure provides, to one of ordinary skill in the art, an enabling description of several embodiments and/or inventions. Some of these embodiments and/or inventions may not be claimed in this patent application, but may nevertheless be claimed in one or more continuing applications that claim the benefit of priority of this patent application. Applicants intend to file additional applications to pursue patents for subject matter that has been disclosed and enabled but not claimed in this patent application.

### VII. 35 U.S.C. § 112, Paragraph 6

In a claim, a limitation of the claim which includes the phrase “means for” or the phrase “step for” means that 35 U.S.C. § 112, paragraph 6, applies to that limitation.

In a claim, a limitation of the claim which does not include the phrase “means for” or the phrase “step for” means that 35 U.S.C. § 112, paragraph 6 does not apply to that limitation, regardless of whether that limitation recites a function without recitation of structure, material or acts for performing that function. For example, in a claim, the mere use of the phrase “step of’ or the phrase “steps of’ in referring to one or more steps of the claim or of another claim does not mean that 35 U.S.C. § 112, paragraph 6, applies to that step(s).

With respect to a means or a step for performing a specified function in accordance with 35 U.S.C. § 112, paragraph 6, the corresponding structure, material or acts described in the specification, and equivalents thereof, may perform additional functions as well as the specified function.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in this patent application. It is well known to one of ordinary skill in the art that a specified function may be implemented via different algorithms, and any of a number of different algorithms would be a mere design choice for carrying out the specified function.

Therefore, with respect to a means or a step for performing a specified function in accordance with 35 U.S.C. § 112, paragraph 6, structure corresponding to a specified function includes any product programmed to perform the specified function. Such structure includes programmed products which perform the function, regardless of whether such product is programmed with (i) a disclosed algorithm for performing the function, (ii) an algorithm that is similar to a disclosed algorithm, or (iii) a different algorithm for performing the function.

### VIII. Disclaimers

Numerous references to a particular embodiment does not indicate a disclaimer or disavowal of additional, different embodiments, and similarly references to the description of embodiments which all include a particular feature does not indicate a disclaimer or disavowal of embodiments which do not include that particular feature. A clear disclaimer or disavowal in this patent application shall be prefaced by a phrase such as “in all embodiments”.

### IX. Incorporation by Reference

Any patent, patent application or other document referred to herein is incorporated by reference into this patent application as part of the present disclosure, but only for purposes of written description in accordance with 35 U.S.C. § 112, paragraph 1 and enablement in accordance with 35 U.S.C. § 112, paragraph 1, and should in no way be used to limit, define, or otherwise construe any term of the present application where the present application, without such incorporation by reference, would not have failed to provide an ascertainable meaning, but rather would have allowed an ascertainable meaning for such term to be provided. Thus, the person of ordinary skill in the art need not have been in any way limited by any embodiments provided in the reference.

Any incorporation by reference does not, in and of itself, imply any endorsement of, ratification of or acquiescence in any statements, opinions, arguments or characterizations contained in any incorporated patent, patent application or other document, unless explicitly specified otherwise in this patent application.

### X. Prosecution History

In interpreting the present application (which includes the claims), one of ordinary skill in the art shall refer to the prosecution history of the present application, but not to the prosecution history of any other patent or patent application, regardless of whether there are other patent applications that are considered related to the present application, and regardless of whether there are other patent applications that share a claim of priority with the present application.

### XI. Overview

Embodiments generally include systems/methods for enabling and/or facilitating wagering and allowing one or more players wager (e.g., via a web site, over a network, etc.) and have a chance to win prizes based on wagers. The players can wager using “points” (or other currency) that may be accumulated through redemption of one or more incentive awards. Incentive awards may be acquired by the player through any of a variety of manners, such as purchasing products, viewing advertising and receiving gifts. Such points and/or other points (e.g., points won through game play) may be used to receive prizes. For example, points may be exchanged for prizes according to a conversion schedule (e.g., certain prizes are worth a specified number of points). Similarly, in some embodiments, consumers may otherwise redeem online points that were earned offline in other manners.

In one particular embodiment, a bottle cap from a purchased beverage may include a code number. The code number may be an indication of an incentive award. The purchaser of the beverage may enter the code number into an interface to redeem wagerable points that may be used in the variety of games. Various outcomes of these games, such as winning a wager, may result in redeemable points being awarded to the purchaser. Thereafter, the purchaser may be able to redeem these points for any merchandise that is available for purchase with these points.

### XII. Incentive Programs Points

Points, such as incentive award points/other wagerable points, may be provided to players according to any method, including as a part of any of a variety of incentive programs.

One type of incentive award program is a bottle cap collection program. In such a program a soft drink merchant may produce soft drinks in disposable packages which include indicia that denote an award or potential award to the player. In the case of bottles, a bottle cap may include indicia with a message indicating whether the player has won or not won. In some embodiments, all bottle caps may be winning bottle caps. A winning bottle cap could be redeemed (e.g., in a store or mailed in to a designated redemption center, through a internet-based interface) to claim a prize. The indicia may include a code (e.g., an alphanumeric code).

Certain incentive award programs are transacted in an online environment such as the Internet. For example, buyers may be able to earn points online, (e.g., by purchasing goods from an online merchant, clicking on advertisements, filling out registrations and surveys, entering codes from purchased products, performing various other activities of interest to merchants, advertisers and other companies). In some embodiments, users accumulate “points” into a balance. Users may be able to redeem these points for goods or services and/or use them in one or more wagers, as described in more detail below.

Certain incentive award programs involve a merchant awarding discounted or free merchandise to loyal and frequent customers. For example, by ordering a regular meal at a restaurant on ten different occasions (e.g., as recorded on a stamped card), a customer may get a discount on a purchase (e.g., receive a 50% discount for the eleventh meal, receive the eleventh meal free). Similarly, a merchant may give a “loyal” customer a free drink with his meal (e.g., after every tenth visit to the merchant or purchase from the merchant). A merchant may give a discount to a new customer (e.g., $10 off the next purchase).

In some embodiments, incentive awards may be provided for a customer that provides information. For example, an incentive award may be provided for a user registering with a website. Such registration may include providing name, address, email, preferences, income, demographic, and/or other information. A size of an incentive award may be based on an amount of information provided. For example, a first size may be awarded a post office address and a second greater size for an email address. The information provided may also include information about other people, such as friends or family. In some embodiments, incentive awards may be provided based on attendance at an event, for example a marketing event or a talk about a particular retailer or product. In other embodiments, incentive rewards may be provided for a customer not performing some act or buying some product.

In some embodiments, an amount of points awarded as part of an incentive award may be at least in part based on a number or frequency of incentive awards awarded to a particular customer. For example, a customer that receives a large number of incentive awards (i.e., a frequent customer) may receive more points per incentive award than a less frequent customer.

In some embodiments, a customer may be able to receive incentive awards/points for “free”. For example, a customer may be able to request a “free” incentive award by mail, by telephone, over the internet, etc. Similarly, the customer or any other person may received a notice of award, e.g., via mail or the internet, without having to perform any action to “earn” the award.

Each of the above incentive award programs includes a feature in which incentive awards of some sort are provided to a customer, or generally to a person or user of the award program. For example, even though an actual physical card may be stamped after each visit to a restaurant or even though a gift certificate may be provided to a customer, such stamped cards and gift certificates are equivalent to points in that each can correspond to an accumulation of actions towards a goal.

Other incentive systems are described in U.S. Patent Publication No. 200410 193489, entitled “offline-online incentive points system and method”, filed Dec. 31, 2003; and U.S. patent application Ser. No. 091638,457, also entitled “OFFLINE-ONLINE INCENTIVE POINTS SYSTEM AND METHOD”, filed Aug. 14, 2000, both of which are hereby incorporated by reference herein as part of the present disclosure.

In various embodiments, a user may be provided with an interface (e.g., a web page), that is, an interface may be displayed through which information about an incentive award may be entered as indicated at block 201 in FIG. 2. The user may enter information about the incentive award (e.g., a code number) and submit the information (e.g., to a server over the Internet). An indication of an incentive award may be received (e.g., by a server or other device) as indicated at block 203 of FIG. 2. The indication may include an indication that any desired event has occurred (e.g., that a sale of a product occurred, that a customer has displayed loyalty, that a survey has been filled out, etc.). The indication may include a coded value that may later be decoded, as described below. The indication may be used to determine some amount of wagerable/incentive points that are to be awarded to a user (e.g., by adding them to the customers balance) as indicated at block 205 of

FIG. 2. A maintained balance of such points may then be adjusted accordingly as indicated at block 205 of FIG. 2.

### XIII. Codes

As described herein, as part of an incentive award program, a customer may be provided with a code. The code may be redeemable for an amount of points. In an embodiment, a code can be provided via a purchased product. For example, a code may be provided via a cap of a soft drink bottle (e.g., printed on the surface of the cap that is unexposed before the cap is removed from the bottle) or otherwise printed upon the packaging of a product or upon the product or may be provided as part of any other incentive award program, as described above.

A plurality of codes can be predefined and printed upon, e.g., packaging or any other medium, or otherwise made available to potential customers. The codes may take any form, and can be generated in a number of manners. For example, a computer (e.g., a general purpose computer which executes software to perform methods described herein) or other computing device can generate a set of alphanumeric codes (e.g., one million codes each of which comprises a sequence of ten alphanumeric characters). In an embodiment, the device which generates the set of codes can assure that each code in the set is unique (i.e. no two codes are the same sequences of alphanumeric characters). In an embodiment, the device which generates the set of codes assures that knowledge of one code does not significantly improve the chances of determining or guessing another of the codes.

According to an embodiment, a C-digit code (a code consisting of a sequence of C characters) is formed from an alphabet of L letters (each of the characters of the code is one of the L letters). In an embodiment, the alphabet consists of 29 letters (e.g., L=29) and is used in generating a 10-digit code (e.g., C=10). Without having acquired a valid code, (e.g., via a bottle cap) a user would find it difficult to accurately guess a valid code.

To generate such codes, an encryption scheme may be employed. One possible encryption scheme involves generating a 48-bit string that includes a number portion and a validation portion. Based on the number portion and a secret key, another string can be created using any of a number of well-known one-way hash functions, such as the MD5 algorithm. Some designated portion of this new string can be extracted and used as the validation portion of the 48-bit string. Having generated such a 48-bit string, the standard DES3 encryption algorithm can be applied to generate another string, which is then converted to base L (e.g., L=29) to generate the C-digit code (e.g., C=10). This code can be then printed (e.g., on a bottle cap, on other product packaging, on products) or otherwise provided to potential players. It should be recognized that these code generation algorithms are given as examples only, and that any method of generating a code may be used in various embodiments.

To verify that the code that a player submits online is indeed an incentive award code, a server or other device can perform the reverse of the encryption operation, except for the MD5 one-way hashing operation which is run forward. The device can first convert the base L code into base 2, and then decrypt the base 2 number to generate a string S. Using one of a plurality of predetermined secret keys, the device can apply the MD5 one-way hash operation to the number portion of the S string to generate a new string S′. The validation portion of this new string S′ is then compared with the validation portion of the string S. If the comparison yields a match, the code would be deemed valid. Otherwise, the code would be deemed invalid. It should be recognized that the MD5 method of code validation is given as an example only, and that any other method of code validation may be used in various embodiments (e.g., comparing a code to a list of valid codes, etc.).

In an embodiment, all codes or other indications of incentive awards may be worth the same amount of points. In another embodiment, different codes or other indications of incentive awards may be worth different amounts of points. In such an embodiment, there can be generated a relatively small number of codes or other indication of incentive awards which are worth relatively large amounts of points, while many or most codes or other indications of incentive awards are worth a relatively small amount of points. The association of codes or other indications of incentive awards and points may be performed in any of a number of manners, such as, e.g., via a table or like data structure which associates one or more codes with a number of points.

### XIV. Games and Gaming

According to various embodiments, a player may employ wagerable points to enter into one or more wagers. Such a wager may be entered through one or more wagering interfaces that allow a user to enter wager related information as indicated at block 207 of FIG. 2.

A user may be provided with a wagering interface through a computer display. The interface may allow a user to choose from a variety of wagers and enter information such as an amount of points wagered. Upon choosing information about the wager, an indication of the wager may be transmitted. A server or other device may receive an indication of a wager of some amount of wagerable points and process the indication appropriately (e.g., store information, monitor an outcome, etc.) as indicated at block 209 of FIG. 2.

A wager may include a variety of online games. Online games include chance-based games, in which players place bets (with an amount of wagered points) on uncertain outcomes. An example of chance-based gaming is gambling, which is typically conducted between one or more players and a party against who they wager, typically referred to as the House, where the House may control the betting, game management and transactions. Additionally or alternatively, one or more players may play against each other. Additionally or alternatively, a plurality of players may cooperate in playing against, e.g., other players or the House. Some games that may be played by players according to various embodiments include a blackjack game, a poker game, a baccarat game, a craps game, a roulette game, a slot machine game, a sic bo game, and other chance-based games. Various embodiments are applicable to any game, including casino-style games, casino table games, card games, dice games, sporting events, games of skill and video games. In some embodiments, a wager may include any other bet about an outcome of an event, such as an outcome of a world event like an election, or other type of event like a sporting competition, a drawing, etc.

In some embodiments, online games may include typical gaming elements, such as one or more users and a House, as well as network based computing devices, by means of which the users may interact with each other and with the House. Such online gaming operations may enable users to choose a game, enter the game by either downloading a computer application or through a web browser, place bets on one or more possible outcomes of a random, pseudo-random or semi-random computer generated event, and make or lose points or money according to the outcome of the bets. The interface (e.g., computer application, web site, etc.) through which a player bets can be completely controlled by the House. The House can be in control of both managing the game and all associated transactions, and may also control the outcome of a random event generator (e.g. computer roulette table) on which a player places their bet.

U.S. Pat. No. 5,800,268, which is hereby incorporated herein by reference as part of the present disclosure, describes a method of participating in a live casino game from a remote location. The '268 patent describes permitting a player to participate in a live casino game and to place bets from a location remote from the casino at which the game is being played. The '268 patent describes a one-way teleconferencing system between a player and a single land based casino.

After an event or game is complete, an outcome of a wager may be determined as indicated at block 211 of FIG. 2. For example, a server of other device may determine if a user won a game of other bet. Based on the outcome of the wager, a point adjustment to a point balance may be determined (e.g., redeemable points, wagerable points, unified points) as indicated at block 213 of FIG. 2. The point adjustment may subsequently be made to a stored point balance as indicated at block 213 of FIG. 2. If the outcome of the wager is such that a user wins the wager, a point adjustment may be added to a point balance. If the outcome is such that a user loses a wager, in some embodiments, no adjustment may be made, and in other embodiments a point adjustment may be subtracted from a point balance.

In some embodiments, wagers may be separated into a set of tiers according to amount of points that may be won by a successful outcome. In some embodiments, users may gain access to some tiers based on a current point balance, a total number of incentive points redeemed, and/or some other criteria. For example, a frequent customer who has been awarded many incentive awards may be able to enter into more advantageous wagers, e.g., ones with better odds, than an infrequent customer who has not been awarded many incentive awards. In some implementations, users enter into wagers/games with other users in different tiers, but point awards may be assigned based on tier so that the user in a higher tier receives more points even when entering into the same game/wager. In some embodiments, a lowest tier may include a free tier in which players with out any incentive awards points may play.

### XV. Game Playing—Environment

In various embodiments, points may be employed to enter wagers in any of a number of game playing environments. For example, games may be played in a known manner online (e.g., via a web/HTML interface, via the internet) via a personal computer or other device which accesses the internet. Additionally or alternatively, games may be played on a device which is in communication with a server across a LAN, WAN or other network. Games may be played via other system architectures, whether or not employing a network.

In a server-based game environment, server functionality can be implemented on a single hardware platform having one or more web servers, or can be distributed among multiple hardware servers, each having one or more web servers and handling one or more of these functions (e.g., integrated web server and messaging server). This functionality includes conventional web server and application server functionality, such as running applications, managing resources, handling web requests, managing files and records, delegating tasks, and handling exceptions, among other tasks.

In an embodiment, a player may play casino games without downloading software to his local computer. Games may be represented in the browser via plugins (e.g., Macromedia Flash, Macromedia Shockwave, or Java) and typically require browser support for the appropriate plugin. Typically, in such an embodiment all graphics, sounds and animations are loaded through the web via the plugin. Alternatively, game play may be employed through an HTML interface, such as one that includes one or more elements implemented using the AJAX programming technique.

In an embodiment, software must be downloaded to the local computer in order to play a game via the local computer. In such an embodiment, online casino software communicates with the server and does not require browser support. Such download-based games generally execute faster than web-based games since the graphics and sound programs typically reside within the software client, rather than having to be loaded via the Internet.

Further examples of online gaming systems are described in U.S. Pat. No. 6,810,528 entitled “System and method for providing an on-line gaming experience through a CATV broadband network” issued to Chatani; and U.S. Pat. No. 6,152,824, entitled “Online gaming architecture” issued to Rothschild, both of which are hereby incorporated by reference herein as part of the present disclosure.

A system of some embodiments may include elements besides those related to playing a game. For example, player information and current player information can be displayed. For example, the top players, and/or top players for each game, can be displayed.

### XVI. Using Points

In some embodiments, a player may be required to register (e.g., via a web site, via the same web site that is accessed to play) in order to redeem incentive awards, place wagers, and or otherwise use any points. For example, a player may be required to provide a (unique) user name and password in a known manner, and the user name and password are stored and serve to identify the player. The player may be requested and/or required to provide other information (e.g., address, demographic information, playing preferences, other preferences). After registration, a player may be permitted to access a game playing system (e.g., logging in by providing his user name and password). Such registration allows various data regarding the player to be recorded and tracked. For example, the registration of a player permits that player's points used and redeemed to be tracked.

To use a code (and the points the code represents), the player can enter the code via an appropriate web page. The web server of other device checks the code to determine whether it is a valid code. If the entered code is a valid code, the server adds the points corresponding to that code to the player's account. In an embodiment, the server may also “mark” the valid code as redeemed (e.g., store an indication in a database) so that the same code cannot be used again.

The player can be notified of the amount of points the entered code is worth (e.g., via a display on the web site). The points that the player has can be used to play games.

### XVII. Balance Adjustment

The number of points available to be used to acquire prizes for the player may be recorded as a player's balance. Such a balance may be increased by winning wagers (e.g., winning a casino game, correctly betting on an event, etc.). In some embodiments, points available to be used to acquire prizes may include the incentive award points, so such a balance may also be increased by a user entering information about incentive awards (e.g., codes). In other embodiments, points available to be used to acquire prizes (i.e., redeemable points) may be separate from incentive award points (i.e., wagerable points). In such embodiments, incentive awards may be limited to having no redeemable value. In some such embodiments, such incentive awards may therefore be used only for use in placing wagers.

Playing and balance adjustment based on play can proceed according to various methods. For example, in an embodiment, a player's balance is adjusted (increased and decreased) in any of several known manners according to conventional play of conventional games (e.g., decreased by wager amounts, increased by amounts won, increased by codes/points applied to the player). In embodiments where wagerable points and redeemable points are maintained in separate balances, for example, a balance of wagerable points may be decreased when a wager is placed, and a balance of redeemable points may be increased if the wager is won.

In an embodiment, each player (or each of a subset of players, such as those players who play in certain states or certain countries) can have a balance of points (e.g., wagerable, redeemable, or a unified balance) that does not decrease for any reason (e.g., no matter how play proceeds). Accordingly, the balance in such an embodiment can be represented as a monotonically non-decreasing function of time, wager, and/or game play. In such an embodiment, a balance may be adjusted according to any of a number of methodologies that render the balance non-decreasing. For example, wagers can be placed and the balance can thus decrease accordingly. Then, all game payouts can be at least a minimum of the amount wagered. Such an embodiment may be used in conjunction with an embodiment in which wagers are the same amount (e.g., all wagers are one point) or all wagers are the same amount for certain games (e.g., all wagers are one point for slot machine games, and two points for all other games).

In another embodiment, wager amounts may not deducted from a balance of points. For example, wagers can be free. In such an embodiment, the number of wagers placed per time (e.g., wagers per hour, amount wagered per hour) can be limited to no more than a maximum.

In an embodiment, wagers are deducted from a different account, rather than being deducted from a balance of points. All players can have a second account (a wagering account) which is replenished (e.g., at a steady rate such as one point per time).

In an embodiment in which balances are non-decreasing, the odds and/or payouts of the games can be adjusted such that many outcomes of games result in zero or low payout of points. For example, the pay tables of the games can be reduced proportionally (all payouts are 10% of what they would otherwise have been).

In some embodiments, multiple users may be able to pool or exchange points. For example, a group of users may wish to contribute to a single balance of redeemable points so that a better prize may be obtained.

### XVIII. Prizes

In some embodiments, a player can use his points to acquire prizes in a known manner. For example, points can be used to purchase goods and services that are listed on a catalog page. A user interface may be provided that displays available prizes and allows a user to redeem points (e.g., points from the redeemable point balance) as indicated at block 215 of FIG. 2. In an embodiment, the web site that permits gaming may provide access to a web page that allows (1) prizes to be displayed with their corresponding point amounts, and/or (2) players to acquire prizes in exchange for points (e.g., through known online purchasing methodology).

In some embodiments, available prizes may be separated into availability tiers based on a number of points in some balance, an amount of game play time, or some other criteria. For example, in one implementation, the best prizes, those in a highest tier, may be limited for redemption by users that have redeemed a desired number of incentive award points. Such limitation may prevent some users that may have a sufficient number of redeemable points earned through wagering from receiving certain prizes until they have participated in an incentive award program to a sufficient degree.

### XIX. Advertising

In an embodiment, players that access the web site or other game playing system can be provided with advertisements (e.g., displayed on the web page adjacent to games being played, displayed in “banner ads”). In an embodiment, a player is provided with advertisements that are selected based on some information available on that player (e.g., time played, games played, points won, registration information). In some embodiments, viewing advertisements and/or clicking on advertisements can increase the points (e.g., redeemable, wagerable, unified) in a players balance.

### XX. Other Embodiments

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the scope of instant invention. Accordingly, the foregoing description and drawings are by way of example only.

What is claimed is:

1. A method comprising:
receiving an indication of an incentive award;
determining an amount of first points that may be used to place a bet in a wager based on the incentive award;
providing an interface through which at least a portion of the amount of the first points may be bet in a wager; and
determining an amount of second points based on an outcome of the wager, in which the second points may be redeemed for a prize.

2. The method of claim 1, in which the incentive award is redeemable only for first points and, in which the first points may not be redeemed for a prize.

3. The method of claim 1, in which the indication of the incentive award includes at least one of an indication of a code, an indication of loyalty to a merchant, and an indication of a sale.

4. The method of claim 1, further comprising providing an interface through which the second points may be exchanged for the prize.

5 . The method of claim 1, in which the outcome of the wager is determined based on an outcome of at least one of a house-based casino-style game, a non-house-based casino-style game, a game of skill, a game of chance, a sporting event, a video game, a card game, a table game, a world event, and a random event.

6. The method of claim 1, in which the interface includes at least one advertisement, the method comprising:
determining an amount of at least one of the first points and the second points earned with a display of the at least one advertisement; and
increasing at least one of a balance of first points and a balance of second points with the amount of points earned with the at least one advertisement.

7. The method of claim 1, further comprising:
receiving an indication of an amount of first points bet with the wager; and
adjusting a balance of first points by at least a portion of the amount of first points bet.

8. The method of claim 1, further comprising:
adjusting a balance of first points by the amount of the first points determined based on the incentive award; and
adjusting a balance of seconds points by the amount of the second points determined based on the outcome of the wager.

9. The method of claim 1, in which the first points may also be redeemed for the prize.

10. The method of claim 9, comprising maintaining a balance of first points that is non-decreasing in response to the wager.

11. A method comprising:
receiving a request for a wager from at least one user;
determining whether the at least one user has a balance of first points sufficient for the wager;
determining an outcome of the wager;
determining an amount of second points associated with an outcome of the wager; and
adjusting a balance of second points to reflect the amount of second points associated with the outcome of the wager, in which second points may be redeemed for a prize.

12. The method of claim 11, further comprising providing an interface through which the second points may be exchanged for the prize.

13. The method of claim 11, in which the outcome of the wager is determined based on an outcome of at least one of a house-based casino-style game, a non-house-based casino-style game, a game of skill, a game of chance, a sporting event, a video game, a card game, a table game, a world event, and a random event.

14. The method of claim 11, further comprising:
Providing an interface through which the wager may be placed.

15. The method of claim 14, in which the interface includes at least one advertisement, the method comprising:
determining an amount of at least one of the first points and the second points earned with a display of the at least one advertisement; and
increasing at least one of a balance of first points and a balance of second points with the amount of points earned with the at least one advertisement.

16. The method of claim 11, further comprising:
receiving an indication of an amount of first points bet with the wager; and
adjusting a balance of first points by at least a portion of the amount of first points bet.

17. The method of claim 11, further comprising:
adjusting a balance of first points by an amount wagered.

18. The method of claim 11, in which the first points may not be redeemed for a prize.

19. The method of claim 11, in which the first points may also be redeemed for the prize.

20. The method of claim 11, comprising maintaining a balance of first points that is non-decreasing in response to the wager.

21. A method comprising:
receiving registration information about a user;
providing an interface through which the user may wager an amount of first points;
selecting an advertisement to include in the interface based on the registration information; and
maintaining a balance of second point that are redeemable for a prize, based on the wager.

22. The method of claim 21, wherein the registration information includes demographic information about the user.

23. The method of claim 21, wherein the interface includes a web page, and the advertisement includes a banner ad.

24. The method of claim 21, further comprising awarding the user an amount of first points for providing the registration information.
